(19) United States
(12) Patent Application Publication
(10) Pub. No.: US 2026/0027936 A1
(43) Pub. Date: Jan. 29, 2026

(54) Multifactor Charge Management for Electric Vehicles

(71) Applicant: Nissan North America, Inc., Franklin, TN (US)

(72) Inventors: Geoffrey Andrew Pettet, Oakland, CA (US); Yoshinori Suzue, Mountain View, CA (US); Liam Pedersen, San Francisco, CA (US)

(21) Appl. No.: 18/787,415

(22) Filed: Jul. 29, 2024

(51) Int. Cl. B60L 53/64; B60L 53/62; B60L 53/66

(52) U.S. Cl. CPC B60L 53/64; B60L 53/62; B60L 53/66; B60L 2250/00

(57) ABSTRACT

System and method for efficient charge management of an electric vehicle. Historical usage data of the electric vehicle is used to forecast usage patterns and to determine optimal charging schedules according to the forecasted usage patterns and considering factors like charging costs and charging-port availability at forecasted destinations. The optimal charging schedules can be dynamically adjusted based on real-time conditions or user-preferences. In addition to reducing total charging costs, the optimal charging schedules can reduce electrical-power grid load and increase battery lifespan.

### TECHNICAL FIELD

This disclosure relates generally to charge management for electric vehicles, and more particularly, to multifactor charge management for reducing recharging costs and maintaining battery health based on personal driving behaviors.

### BACKGROUND

Electric vehicles (EVs) have emerged as an alternative to traditional gasoline-powered vehicles, offering potentially lower operating costs. Home charging stations can provide a convenient means for EV owners to recharge their vehicles overnight, while public charging stations can provide faster recharging or a necessary recharging during an extended trip away from home. However, electricity costs and charging rates can vary between home and public charging stations. Further, electricity rates may change in real time due to excess demand. Further still, personal driving behaviors and environmental conditions can affect battery health, e.g., battery performance and longevity. These factors can result in excessive electricity costs to the EV owner, unnecessary loads on an electricity grid, and shortened lifespans of EV batteries.

### SUMMARY

Disclosed herein are aspects, features, elements, implementations, and embodiments of a method, a system, and a non-transitory computer-readable medium for multifactor charge management for electric vehicles. Charge management concerns managing the state-of-charge (SoC) of the battery system of an EV, for example, via intelligent scheduling of charging activities. For example, U.S. patent application Ser. No. 18/309,767, incorporated herein by reference, discloses an EV-charging control device that manages multiple charging schedules for multiple electric vehicles at a charging station according to the charging activity of other vehicles; U.S. patent application Ser. No. 18/309,772, incorporated herein by reference, discloses an EV-charging control device that utilizes vehicle and building profile data to generate and update a driver charging profile, subsequently generating a charging schedule for the EV, which can be executed upon user confirmation through an electronic interface; and U.S. patent application Ser. No. 18/309,763, incorporated herein by reference, discloses an EV-charging control device that schedules charging based on user access to a building's charging port or charging unit, using stored vehicle profile data, and manages charging and discharging periods, controlling the port accordingly.

Multifactor charge management enables users to minimize charging costs of a battery of an EV and to maximize the health of the battery by determining, for example, charging locations, charging times, charging durations, and charging rates for a battery of an EV. Charging costs may include, for example, electricity costs and service fees. Battery health may include, for example, battery performance (e.g., charging and discharging capabilities, thermal management, and storage capacity) and battery longevity (e.g., performance maintenance over an expected lifetime of the battery). The health of a battery may degrade over time due to, for example, personal driving behaviors, battery charging and/or discharging rates, battery discharge depths, and environmental conditions. In one implementation, multifactor charge management comprises three interacting optimizers: a long-term battery optimizer, a multi-session optimizer, and a single-session optimizer.

The long-term battery optimizer concerns the long-term impacts of repeated cycles of charging and discharging on a battery's state-of-health (SoH). The long-term battery optimizer determines the state-of-health based on prior charging sessions (e.g., fast charging and slow charging), prior discharging events (e.g., discharge depths and discharge rates, for example, due to vehicle accelerations), and environmental conditions (e.g., temperature of the environment of the EV). In some implementations, the long-term battery optimizer utilizes one or more battery degradation models to model how prior charging sessions, prior discharging events, and environmental conditions (prior and/or current) affects the state-of-health (e.g., battery performance and longevity). The long-term battery optimizer determines a maximum charging rate of the battery based on the state-of-health. In one implementation, a method that includes the long-term battery optimizer comprises: obtaining at least one of: prior-charging data about the battery comprising at least one of fast-charging sessions, slow-charging sessions, and battery discharge depths; a temperature of an environment of the electric vehicle; or additional prior-usage data comprising accelerations of the electric vehicle; determining a state-of-health of the battery based on at least one of the prior-charging data, the temperature, or the additional prior- usage data; and determining a maximum charging rate for the battery, based on the state-of-health, to satisfy a state-of-health target.

The multi-session optimizer concerns the charging behavior of multiple charging sessions (e.g., over a planning horizon of one or more days, one or more weeks, or longer). In some implementations, the multi-session optimizer utilizes a personalized driver behavioral model to forecast the electric vehicle's usage over the planning horizon, e.g., a predicted-usage schedule, and accordingly, to forecast the electric vehicles energy requirements over the planning horizon. The multisession optimizer obtains electricity costs at one or more predicted locations and predicted times of the predicted-usage schedule and generates a charging schedule to minimize the total charging cost for the predicted-usage schedule. The charging schedule comprises how much charging should occur at respective charging locations, i.e., how much to adjust the state-of-charge of a battery of the EV, where adjusting the state-of-charge may include increasing or decreasing the state-of-charge. The multi-session optimizer may incorporate the maximum charging rate, determined by the long-term battery optimizer, into the charging schedule. In one implementation, a method that includes the multi-session optimizer comprises: obtaining a state-of-charge of a battery of an electric vehicle; obtaining prior-usage data about the electric vehicle comprising departure times, departure locations, and arrival locations; determining a predicted-usage schedule, comprising departure times, departure locations, and arrival locations of one or more predicted usages of the electric vehicle, based on the prior-usage data; determining whether there are charging units in respective vicinities of the departure locations or the arrival locations; determining charging costs at the charging units; generating a charging schedule, for the battery, based on the state-of-charge, the predicted-usage schedule, and the charging costs, the charging schedule having charging periods for adjusting the state-of-charge to accommodate the one or more predicted usages at a minimal total charging cost; and causing an individual one of the charging units to adjust the state-of-charge in accordance with the charging schedule. In some implementations, the charging schedule is adjusted to satisfy the maximum charging rate determined by the long-term battery optimizer.

The single-session optimizer concerns dynamically adjusting a charging session of a charging schedule based on real-time variations in relevant parameters, including, for example, real-time electricity prices, real-time traffic conditions, and real-time availability of charging stations. In one implementation, a method that includes the single-session optimizer comprises:

dynamically adjusting the charging schedule based on real-time variations in electricity prices; dynamically adjusting the charging schedule based on real-time traffic conditions; or dynamically adjusting the charging schedule based on real-time availability of charging units.

### BRIEF DESCRIPTION OF THE DRAWINGS

The various aspects of the methods and systems disclosed herein will become more apparent by referring to the examples provided in the following description and drawings in which like reference numbers refer to like elements unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a block diagram of an example internal configuration of a computing device of an electronic computing and communications system in which the aspects, features, and elements disclosed herein may be implemented.

FIG. 4 is a diagram of an example of a system comprising a charging manager communicatively coupled to one or more charging units.

FIG. 5 is a diagram of an example of a prior-usage data or a predicted usage schedule for an electric vehicle.

FIG. 6 is an example of a charging schedule.

FIG. 7 is a flowchart of an example of a process for determining a charging schedule.

FIG. 8 is a flowchart of an example of a process for adjusting a charging schedule based on a state-of-health of a battery of the electric vehicle.

FIG. 9 is a flowchart of an example of a process for adjusting a charging schedule based on real-time parameters.

### DETAILED DESCRIPTION

To describe some implementations in greater detail, reference is made to the following figures.

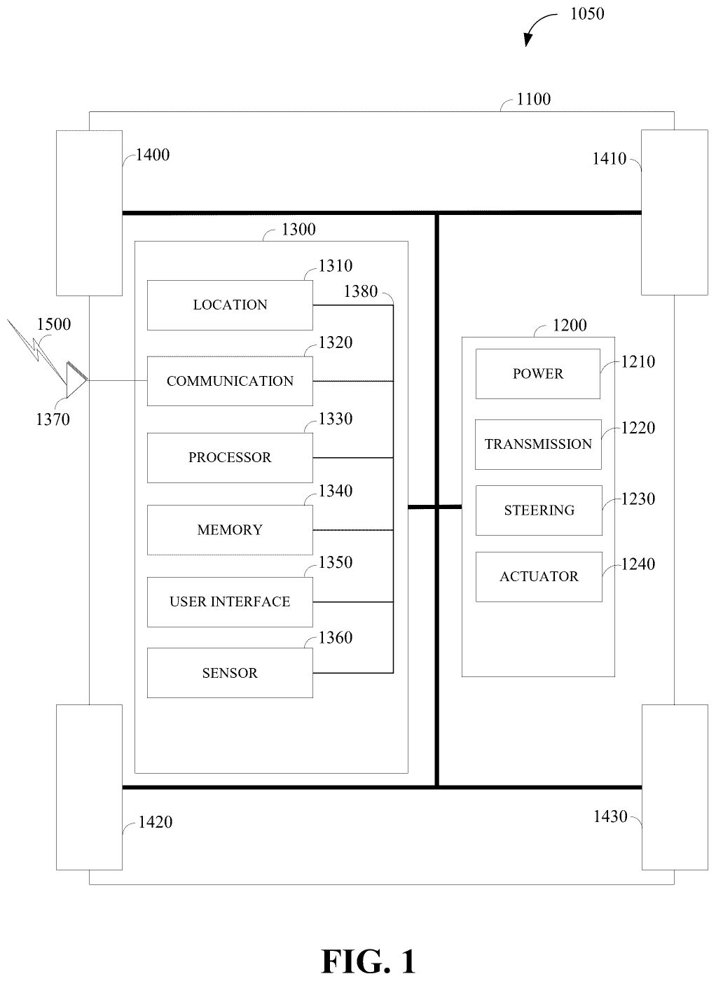

FIG. 1 is a diagram of an example of a vehicle 1050 in which certain aspects, features, and elements disclosed herein may be implemented. The vehicle 1050 may include a chassis 1100, a powertrain 1200, a controller 1300, wheels 1400/1410/1420/1430, or any other element or combination of elements of a vehicle. Although the vehicle 1050 is shown as including four wheels 1400/1410/1420/1430 for simplicity, any other propulsion device or devices, such as a propeller or tread, may be used. In FIG. 1, the lines interconnecting elements, such as the powertrain 1200, the controller 1300, and the wheels 1400/1410/1420/1430, indicate that information, such as data or control signals, power, such as electrical power or torque, or both information and power, may be communicated between the respective elements. For example, the controller 1300 may receive power from the powertrain 1200 and communicate with the powertrain 1200, the wheels 1400/1410/1420/1430, or both, to control the vehicle 1050, which can include accelerating, decelerating, steering, or otherwise controlling the vehicle 1050.

The powertrain 1200 includes a power source 1210, a transmission 1220, a steering unit 1230, a vehicle actuator 1240, or any other element or combination of elements of a powertrain, such as a suspension, a drive shaft, axles, or an exhaust system. Although shown separately, the wheels 1400/1410/1420/1430 may be included in the powertrain 1200. A braking system may be included in the vehicle actuator 1240.

The power source 1210 may be any device or combination of devices operative to provide energy, such as electrical energy, chemical energy, or thermal energy. For example, the power source 1210 includes an engine, such as an internal combustion engine, an electric motor, or a combination of an internal combustion engine and an electric motor, and is operative to provide energy as a motive force to one or more of the wheels 1400/1410/1420/1430. In some embodiments, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy from the power source 1210 and transmits the energy to the wheels 1400/1410/1420/1430 to provide a motive force. The transmission 1220 may be controlled by the controller 1300, the vehicle actuator 1240 or both. The steering unit 1230 may be controlled by the controller 1300, the vehicle actuator 1240, or both and controls the wheels 1400/1410/1420/1430 to steer the vehicle. The vehicle actuator 1240 may receive signals from the controller 1300 and may actuate or control the power source 1210, the transmission 1220, the steering unit 1230, or any combination thereof to operate the vehicle 1050.

In some embodiments, the controller 1300 includes a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof can be integrated in one or more electronic units, circuits, or chips.

In some embodiments, the processor 1330 includes any device or combination of devices capable of manipulating or processing a signal or other information now existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an application-specific integrated circuits (ASICs), one or more field-programmable gate arrays (FPGAs), one or more programmable logic arrays (PLAs), one or more programmable logic controllers (PLCs), one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

In some embodiments, the processor 1330 may be configured to execute instructions including instructions for remote operation which may be used to operate the vehicle 1050 from a remote location including a data-processing center. The instructions for remote operation may be stored in the vehicle 1050 or received from an external source such as a traffic management center, or server computing devices, which may include cloud-based server computing devices. The processor 1330 may be configured to execute instructions for following a projected path as described herein.

The memory 1340 may include any tangible non-transitory computer-usable or computer-readable medium, capable of, for example, containing, storing, communicating, or transporting machine readable instructions or any information associated therewith, for use by or in connection with the processor 1330. The memory 1340 is, for example, one or more solid state drives, one or more memory cards, one or more removable media, one or more read only memories, one or more random access memories, one or more solid-state drives, one or more disks, including a hard disk, a floppy disk, an optical disk, a magnetic or optical card, or any type of non-transitory media suitable for storing electronic information, or any combination thereof.

The electronic communication interface 1370 may be a wireless antenna, as shown, a wired communication port, an optical communication port, or any other wired or wireless unit capable of interfacing with a wired or wireless electronic communication medium 1500.

The electronic communication unit 1320 may be configured to transmit or receive signals via the wired or wireless electronic communication medium 1500, such as via the electronic communication interface 1370. Although not explicitly shown in FIG. 1, the electronic communication unit 1320 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 1320 and a single one of the electronic communication interface 1370, any number of communication units and any number of communication interfaces may be used. In some embodiments, the electronic communication unit 1320 can include a dedicated short-range communications (DSRC) unit, a wireless safety unit (WSU), IEEE 802.11p (WiFi-P), a cellular communication unit such as a long-term evolution (LTE) or 5G transceiver, or a combination thereof.

The location unit 1310 may determine geolocation information, including but not limited to longitude, latitude, elevation, direction of travel, or speed, of the vehicle 1050. For example, the location unit includes a global navigation satellite system (GNSS) unit (e.g., a global positioning system (GPS) unit), a wide area augmentation system (WAAS) enabled National Marine-Electronics Association (NMEA) unit, a radio triangulation unit, or a combination thereof. The location unit 1310 can be used to obtain information that represents, for example, a current heading of the vehicle 1050, a current position of the vehicle 1050 in two or three dimensions, a current angular orientation of the vehicle 1050, or a combination thereof.

The user interface 1350 may include any unit capable of being used as an interface by a person, including any of a virtual keypad, a physical keypad, a touchpad, a display, a touchscreen, a speaker, a microphone, a video camera, a sensor, and a printer. The user interface 1350 may be operatively coupled with the processor 1330, as shown, or with any other element of the controller 1300. Although shown as a single unit, the user interface 1350 can include one or more physical units. For example, the user interface 1350 includes an audio interface for performing audio communication with a person, and a touch display for performing visual and touch based communication with the person.

The sensor 1360 may include one or more sensors, such as an array of sensors, which may be operable to provide information that may be used to control the vehicle. The sensor 1360 can provide information regarding current operating characteristics of the vehicle or its surrounding. The sensors 1360 include, for example, a speed sensor, acceleration sensors, a steering angle sensor, traction-related sensors, braking-related sensors, or any sensor, or combination of sensors, that is operable to report information regarding some aspect of the current dynamic situation of the vehicle 1050.

In some embodiments, the sensor 1360 may include sensors that are operable to obtain information regarding the physical environment surrounding the vehicle 1050. For example, one or more sensors detect road geometry and obstacles, such as fixed obstacles, vehicles, cyclists, and pedestrians. In some embodiments, the sensor 1360 can be or include one or more video cameras, laser-sensing systems, infrared-sensing systems, acoustic-sensing systems, or any other suitable type of on-vehicle environmental sensing device, or combination of devices, now known or later developed. In some embodiments, the sensor 1360 and the location unit 1310 are combined.

Although not shown separately, the vehicle 1050 may include a trajectory controller. For example, the controller 1300 may include a trajectory controller. The trajectory controller may be operable to obtain information describing a current state of the vehicle 1050 and a route planned for the vehicle 1050, and, based on this information, to determine and optimize a trajectory for the vehicle 1050. In some embodiments, the trajectory controller outputs signals operable to control the vehicle 1050 such that the vehicle 1050 follows the trajectory that is determined by the trajectory controller. For example, the output of the trajectory controller can be an optimized trajectory that may be supplied to the powertrain 1200, the wheels 1400/1410/1420/1430, or both. In some embodiments, the optimized trajectory can control inputs such as a set of steering angles, with each steering angle corresponding to a point in time or a position. In some embodiments, the optimized trajectory can be one or more paths, lines, curves, or a combination thereof.

One or more of the wheels 1400/1410/1420/1430 may be a steered wheel, which is pivoted to a steering angle under control of the steering unit 1230, a propelled wheel, which is torqued to propel the vehicle 1050 under control of the transmission 1220, or a steered and propelled wheel that steers and propels the vehicle 1050.

A vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

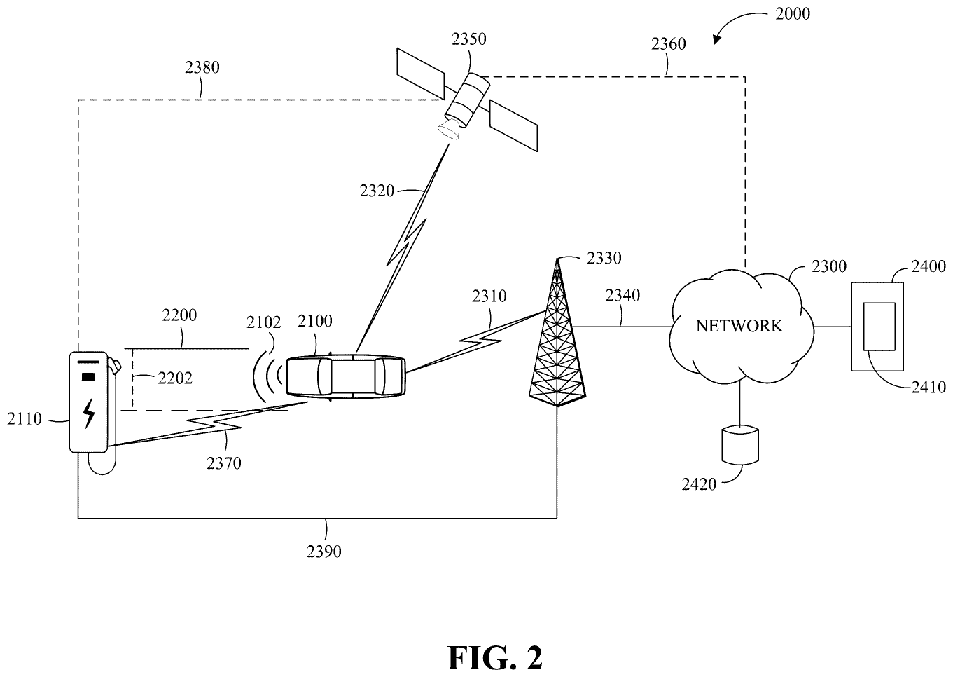

FIG. 2 is a diagram of an example of a portion of a vehicle transportation and communication system 2000 in which certain aspects, features, and elements disclosed herein may be implemented. The vehicle transportation and communication system 2000 includes a vehicle 2100, such as the vehicle 1050 shown in FIG. 1, and one or more external objects, such as an external object 2110, which can include any form of transportation, such as the vehicle 1050 shown in FIG. 1, a pedestrian, a cyclist, as well as any form of a structure, such as a building, a charging unit, and so on. The terms charging arrangement, charging station, charging unit, and charging port may be used interchangeably herein. There are different levels of charging units used by charging systems to charge electric vehicles. As used herein, the terms “electric vehicle,” and in some instances “vehicle” according to the context, mean any vehicle that requires electrical charging, whether the vehicle is all electric or a hybrid, and includes any electric or hybrid operated transportation device.

A Level I charging arrangement typically employs a cord and plug connection and is rated at 120 VAC, being compatible with most commonly available grounded electrical outlets. A Level I charging connector can be transported in the vehicle with which it is used, and any required AC-to-DC converter circuitry typically resides onboard the vehicle. Level I charging arrangements are typically used in a home setting due to the length of time (e.g., 10-24 hours) required to fully charge a propulsion battery.

A Level II charging unit typically employs a permanently wired electrical supply and charging connector and is thus located at a fixed location. Level II charging units are typically rated for less than or equal to 240 VAC, and as with Level I charging arrangements any required AC-to-DC converter circuitry typically resides onboard the vehicle. Level II charging units are often used in the home and in publicly accessible locations, even though the length of time (e.g., 4-8 hours) required for a battery charge capacity is still considerable.

A Level III charging unit also typically employs a permanently wired electrical supply and charging connector. Each Level III charging unit has an AC charging source that receives current from the power or utility grid. Unlike Level I and Level II charging arrangements or units, Level III charging units typically include any required AC-to-DC converter circuitry needed to charge a propulsion battery due to cost and weight constraints. Level III charging units are typically rated to output 400-500 VDC. While it is conceivable for Level III charging units to be used in a home setting, they are typically only used in public settings due to the high expense and because residential structures are not typically supplied with current from electric utilities at such a high voltage. In essence, Level III charging units can significantly reduce charging times (e.g., 30-60 minutes for a battery charge capacity).

Electric vehicle charging stations utilizing charging arrangements or units as described above are being placed in public and private parking areas, municipalities, governments, city streets and interstates, as non-limiting examples. As vehicles requiring charging become more prevalent, vehicle owners will need to be able to re-charge their vehicles virtually anywhere. Charging units supporting multiple vehicles simply duplicate a single charger configuration. The more vehicles supported, the larger the charging unit and the larger the required AC electrical feed to the charging unit. Operators of the public and private parking areas, municipalities, governments, city streets and interstates may desire vehicle charging units that are capable of charging the largest number of vehicles in the least amount of time while being economically efficient.

The vehicle 2100 may travel via one or more portions of a transportation network 2200, and may communicate with the external object 2110, e.g., a charging unit, via one or more of an electronic communication network 2300. Although not explicitly shown in FIG. 2, a vehicle may traverse an area that is not expressly or completely included in a transportation network, such as an off-road area. In some embodiments the transportation network 2200 may include one or more of a vehicle detection sensor 2202, such as an inductive loop sensor, which may be used to detect the movement of vehicles on the transportation network 2200.

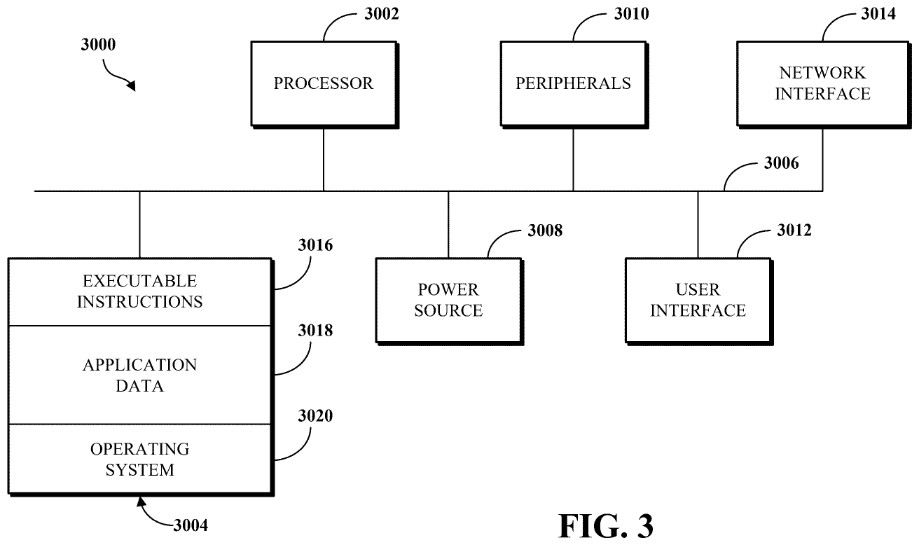

The electronic communication network 2300 may be a multiple-access system that provides for communication, such as voice communication, data communication, video communication, messaging communication, or a combination thereof, between the vehicle 2100, the external object 2110, and a data-processing center 2400. For example, the vehicle 2100 or the external object 2110 may send information to, or receive information from, the data-processing center 2400 or a database server 2420, via the electronic communication network 2300, such as information representing the transportation network 2200. The data-processing center 2400 includes a computing apparatus 2410, that includes some or all of the features of the computing device 3000 shown in FIG. 3. In some implementations, the data-processing center 2400 includes the database server 2420. The database server 2420 is configured for storing data, and it may be implemented by a suitable computer storage medium.

The data-processing center 2400 can monitor and coordinate the movement of vehicles, including autonomous vehicles. The data-processing center 2400 may monitor the state or condition of vehicles, such as the vehicle 2100, and external objects, such as the external object 2110. The data-processing center 2400 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the data-processing center 2400 can establish remote control over one or more vehicles, such as the vehicle 2100, or external objects, such as the external object 2110. In this way, the data-processing center 2400 may tele-operate the vehicles or charging units from a remote location. The computing apparatus 2410 may exchange (send or receive) state data with vehicles, charging units, or computing devices such as the vehicle 2100, the external object 2110, or the database server 2420, via a wireless communication link such as the wireless communication link 2380 or a wired communication link such as the wired communication link 2390.

In some embodiments, the vehicle 2100 or the external object 2110 communicates via the wired communication link 2390, a wireless communication link 2310/2320/2370, or a combination of any number or types of wired or wireless communication links. For example, as shown, the vehicle 2100 or the external object 2110 communicates via a terrestrial wireless communication link 2310, via a non-terrestrial wireless communication link 2320, or via a combination thereof. In some implementations, a terrestrial wireless communication link 2310 includes an Ethernet link, a serial link, a Bluetooth link, an infrared (IR) link, an ultraviolet (UV) link, or any link capable of providing for electronic communication.

A vehicle, such as the vehicle 2100, or an external object, such as the external object 2110, may communicate with another vehicle, external object, or the data-processing center 2400. For example, a host, or subject, vehicle 2100 may receive one or more automated inter-vehicle messages, such as a basic safety message (BSM), from the data-processing center 2400, via a direct communication link 2370, or via an electronic communication network 2300. For example, data-processing center 2400 may broadcast the message to host vehicles within a defined broadcast range, such as three hundred meters, or to a defined geographical area. In some embodiments, the vehicle 2100 receives a message via a third party, such as a signal repeater (not shown) or another remote vehicle (not shown). In some embodiments, the vehicle 2100 or the external object 2110 transmits one or more automated inter-vehicle or inter-object messages periodically based on a defined interval, such as one hundred milliseconds.

Automated inter-vehicle or inter-object messages may include vehicle identification information; geospatial state information, such as longitude, latitude, or elevation information; geospatial location accuracy information; kinematic state information, such as vehicle acceleration information, yaw rate information, speed information, vehicle heading information, braking system state data, throttle information, steering wheel angle information, or vehicle routing information; or vehicle operating state information, such as vehicle size information, headlight state information, turn signal information, wiper state data, transmission information, state-of-charge information, e.g., amount of charge in one or more batteries or battery systems, or any other information, or combination of information, relevant to the transmitting vehicle state. For example, transmission state information indicates whether the transmission of the transmitting vehicle is in a neutral state, a parked state, a forward state, or a reverse state.

In some embodiments, the vehicle 2100 communicates with the electronic communication network 2300 via an access point 2330. The access point 2330, which may include a computing device, may be configured to communicate with the vehicle 2100, with the electronic communication network 2300, with the data-processing center 2400, or with a combination thereof via wired or wireless communication links 2310/2340. For example, an access point 2330 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 2100 may communicate with the electronic communication network 2300 via a satellite 2350, or other non-terrestrial communication device. The satellite 2350, which may include a computing device, may be configured to communicate with the vehicle 2100, with the electronic communication network 2300, with the data-processing center 2400, or with a combination thereof via one or more communication links 2320/2360. Although shown as a single unit, a satellite can include any number of interconnected elements.

The electronic communication network 2300 may be any type of network configured to provide for voice, data, or any other type of electronic communication. For example, the electronic communication network 2300 includes a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network can include any number of interconnected elements.

In some embodiments, the vehicle 2100 and/or the external object 2110 communicates with the data-processing center 2400 via the electronic communication network 2300, access point 2330, or satellite 2350. The data-processing center 2400 may include one or more computing devices, which are able to exchange (send or receive) data from: vehicles such as the vehicle 2100; external objects including the external object 2110; or storage devices such as the database server 2420.

In some embodiments, the vehicle 2100 identifies a portion or condition of the transportation network 2200. For example, the vehicle 2100 may include one or more on-vehicle sensors 2102, such as the sensor 1360 shown in FIG. 1, which includes a speed sensor, a wheel speed sensor, a camera, a gyroscope, an optical sensor, a laser sensor, a radar sensor, a sonic sensor (e.g., a microphone or acoustic sensor), a compass, or any other sensor or device or combination thereof capable of determining or identifying a portion or condition of the transportation network 2200.

The vehicle 2100 may traverse one or more portions of the transportation network 2200 using information communicated via the electronic communication network 2300, such as information representing the transportation network 2200, information identified by one or more on-vehicle sensors 2102, or a combination thereof. The external object 2110 may be capable of all or some of the communications and actions described above with respect to the vehicle 2100.

For simplicity, FIG. 2 shows the vehicle 2100 as a subject vehicle, the external object 2110 as a charging unit, the transportation network 2200, the electronic communication network 2300, and the data-processing center 2400. However, any number of vehicles, objects, networks, or computing devices may be used. In some embodiments, the vehicle transportation and communication system 2000 includes devices, units, or elements not shown in FIG. 2. Although the vehicle 2100 or external object 2110 is shown as a single unit, a vehicle can include any number of interconnected elements.

Although the vehicle 2100 is shown communicating with the data-processing center 2400 via the electronic communication network 2300, the vehicle 2100 (and external object 2110) may communicate with the data-processing center 2400 via any number of direct or indirect communication links. For example, the vehicle 2100 or external object 2110 may communicate with the data-processing center 2400 via a direct communication link, such as a Bluetooth communication link. Although, for simplicity, FIG. 2 shows one of the transportation network 2200, and one of the electronic communication network 2300, any number of networks or communication devices may be used. The vehicle 2100 (and external object 2110) can be monitored or coordinated by the data-processing center 2400, can be operated autonomously or by a human operator, and can exchange (send and receive) vehicle data relating to the state or condition of the vehicle and its surroundings including any of vehicle velocity (e.g., vehicle speed and vehicle trajectory, or heading); vehicle location; vehicle operational state; vehicle destination; vehicle route; vehicle sensor data; external object velocity; external object location, and so on.

FIG. 3 shows a block diagram of an example of a computing device 3000 in which certain aspects, features, and elements disclosed herein may be implemented. The computing device 3000 includes components or units, such as a processor 3002, a memory 3004, a bus 3006, a power source 3008, peripherals 3010, a user interface 3012, a network interface 3014, other suitable components, or a combination thereof. One or more of the memory 3004, the power source 3008, the peripherals 3010, the user interface 3012, or the network interface 3014 can communicate with the processor 3002 via the bus 3006.

The processor 3002 is a central processing unit, such as a microprocessor, and can include single or multiple processors having single or multiple processing cores. Alternatively, the processor 3002 can include another type of device, or multiple devices, configured for manipulating or processing information. For example, the processor 3002 can include multiple processors interconnected in one or more manners, including hardwired or networked. The operations of the processor 3002 can be distributed across multiple devices or units that can be coupled directly or across a local area or other suitable type of network. The processor 3002 can include a cache, or cache memory, for local storage of operating data or instructions.

The memory 3004 includes one or more memory components, which may each be volatile memory or non-volatile memory. For example, the volatile memory can be random access memory (RAM) (e.g., a DRAM module, such as DDR SDRAM). In another example, the non-volatile memory of the memory 3004 can be a disk drive, a solid state drive, flash memory, or phase-change memory. In some implementations, the memory 3004 can be distributed across multiple devices. For example, the memory 3004 can include network-based memory or memory in multiple clients or servers performing the operations of those multiple devices.

The memory 3004 can include data for immediate access by the processor 3002. For example, the memory 3004 can include executable instructions 3016, application data 3018, and an operating system 3020. The executable instructions 3016 can include one or more application programs, which can be loaded or copied, in whole or in part, from non-volatile memory to volatile memory to be executed by the processor 3002. For example, the executable instructions 3016 can include instructions for performing techniques of this disclosure. In some implementations, the application data 3018 can include functional programs, such as a computational programs, analytical programs, database programs, and so on. The operating system 3020 can be, for example, Microsoft Windows®, Mac OS X®, or Linux®; an operating system for a mobile device, such as a smartphone or tablet device; or an operating system for a non-mobile device, such as a mainframe computer.

The power source 3008 provides power to the computing device 3000. For example, the power source 3008 can be an interface to an external power distribution system. In another example, the power source 3008 can be a battery, such as where the computing device 3000 is a mobile device or is otherwise configured to operate independently of an external power distribution system. In some implementations, the computing device 3000 may include or otherwise use multiple power sources. In some such implementations, the power source 3008 can be a backup battery.

The peripherals 3010 may include one or more sensors, detectors, or other devices configured for monitoring the computing device 3000 or the environment around the computing device 3000. For example, the peripherals 3010 can include a geolocation component, such as a GNSS location unit (e.g., GPS). In another example, the peripherals can include a temperature sensor for measuring temperatures of components of the computing device 3000, such as the processor 3002. In some implementations, the computing device 3000 can omit the peripherals 3010.

The user interface 3012 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 3014 provides a connection or link to a network (e.g., the electronic communication network 2300 shown in FIG. 2). The network interface 3014 can be a wired network interface or a wireless network interface. The computing device 3000 can communicate with other devices via the network interface 3014 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 3000 can communicate with a database server, such as the database server 2420 of FIG. 2.

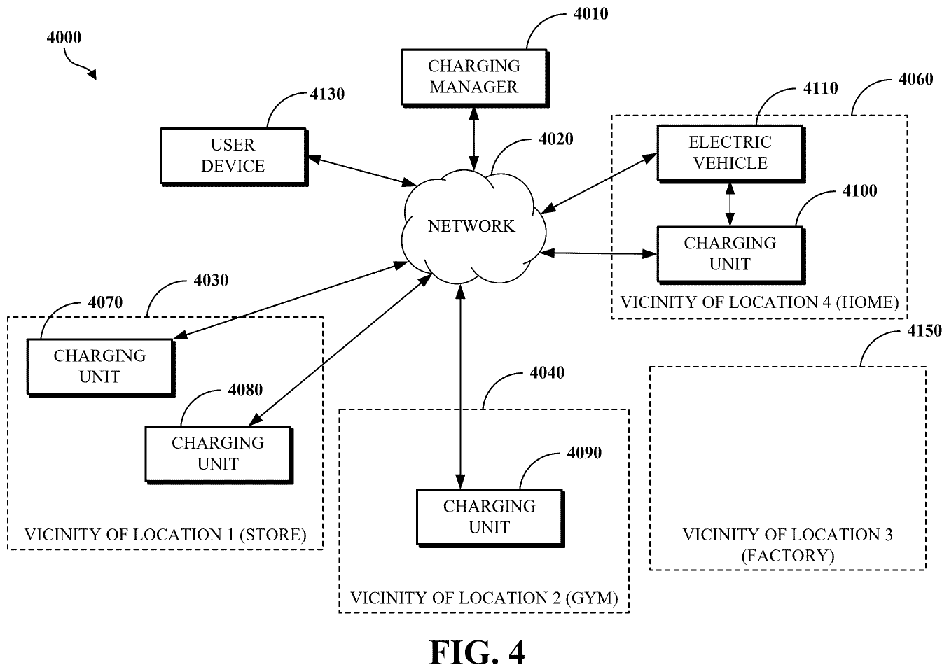

FIG. 4 is a diagram of an example of a system 4000 comprising a charging manager 4010 communicatively coupled to one or more charging units 4070, 4080, 4090, and 4100 in which certain aspects, features, and elements disclosed herein may be implemented. A network 4020, such as the electronic communication network 2300 of FIG. 2, connects a number of components, including a charging manager 4010, a user device 4130, an electric vehicle 4110, and one or more charging units 4070, 4080, 4090, and 4100. The charging manager 4010 may be one or more hardware instances of the computing device 3000, or it may be one or more software instances executing on one or more computing devices 3000, or it may be a combination thereof. In some implementations, the charging manager 4010 may be comprised the data-processing center 2400 of FIG. 2. The user device may be an instance of the computing device 3000, such as a smartphone or tablet. The electric vehicle may be, for example, the vehicle 2100 of FIG. 2, and each charging unit 4070, 4080, 4090, and 4100 may be, for example, respective instances of the external object 2110 of FIG. 2. The charging manager 4010 may implement aspects of a multi-session optimizer, a single-session optimizer, and a long-term battery optimizer, as described more fully below.

With respect to implementation of a multi-session optimizer, the charging manager 4010 obtains a state-of-charge of a battery of the electric vehicle 4110. The charging manager 4010 also obtains prior-usage data, for the electric vehicle 4110, comprising information indicating, for example, departure times, departure locations, and arrival locations of previous trips made by the electric vehicle 4110. The state-of-charge and prior-usage data may be obtained, for example, via a connection through the network 4020 to the electric vehicle 4110 or by way of a connection through the network 4020 to a charging unit, such as the charging unit 4100, that is or was recently connected to the electric vehicle 4110. The electric vehicle 4110, may, in turn, collect state-of-charge data via the sensor 1360 of FIG. 1 and location data via the location unit 1310 of FIG. 1. In some implementations, the charging manager 4010 may obtain location data via a location sensor, such as a GPS unit, of the user device 4130, for example, a driver's smartphone.

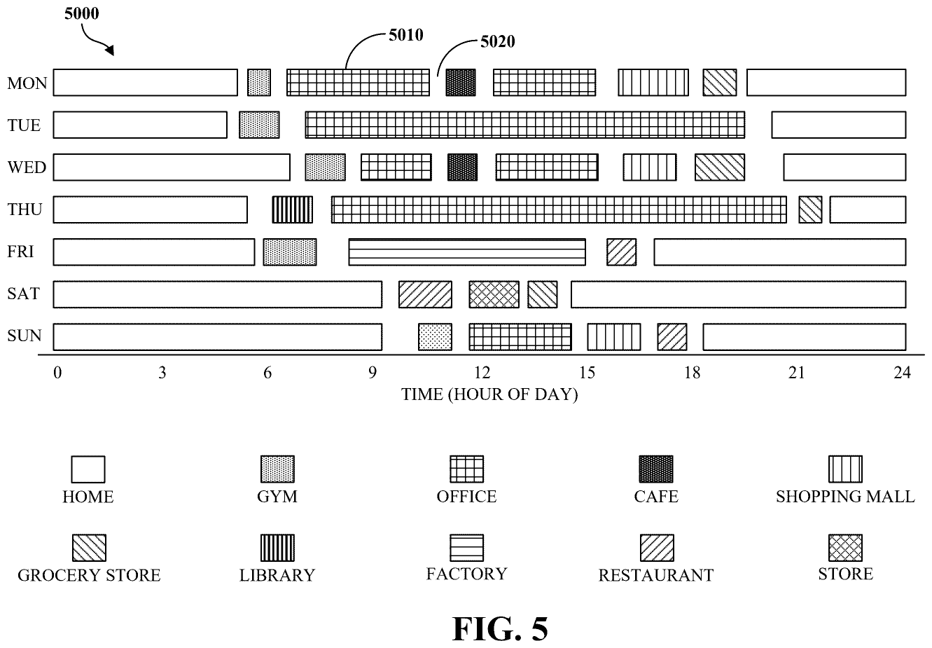

FIG. 5 is a diagram of an example of a prior-usage data 5000 (or a predicted-usage schedule 5000, as described later herein) for the electric vehicle 4110. FIG. 5 shows past locations of the electric vehicle 4110 as a function of time. In the example of FIG. 5, a week of prior usages is shown; however, a shorter duration, such as days, or a longer duration, such as months or even years, could be used. Further, prior-usage data may be collected at varying resolutions, for example, every minute, every five minutes, and so on, where finer data-collection resolution may result in a more accurate predicted-usage schedule, as described below, at the expense of increase memory and computational requirements of the charging manager 4010.

Example locations 5010 shown in FIG. 5 include home, gym, office, cafe, shopping mall, grocery store, library, factory, restaurant, and store, and the empty spaces 5020 between the locations 5010 indicate times when the electric vehicle 4110 was in between locations, for example, it was being driven from a first location to a second location. In some implementations, a location 5010 may be considered a physical location where the electric vehicle 4110 stopped and the driver disembarked for at least a predefined duration. Although the location labels in FIG. 5 are a convenient abstraction, a location may be defined by a physical region, or vicinity, around the electric vehicle 4110 during driver-disembarkation. FIG. 4 shows several example vicinities 4030, 4040, 4050, and 4060. The area, or perimeter, of any given vicinity may be based on, for example, the density of infrastructure where, for example, vicinities in a metropolitan area may cover less area than vicinities in a rural area. In some implementations, a user may provide input to the charging manager 4010 to specify areas and shapes of various vicinities, for example, by drawing a shape around a location indicated on a map or satellite image via a graphical user display.

Based on the prior-usage data, the charging manager 4010 determines a predicted-usage schedule, comprising departure times, departure locations, and arrival locations of one or more predicted usages of the electric vehicle 4110. As indicated above, FIG. 5 is a diagram of an example of a predicted-usage schedule 5000 (or prior-usage data 5000, as described above) for the electric vehicle 4110. In some implementations, the predicted-usage schedule may consist or a shorter or longer duration than that shown in FIG. 5. In some implementations, the predicted-usage schedule is determined using one or more machine-learning algorithms (which may also be referred to herein as artificial-intelligence algorithms). Various suitable machine-learning algorithms are known in the art and are therefore not detailed herein. In the context of determining the predicted-usage schedule, a machine learning algorithm may be trained on the prior-usage data. Thus, initial predicted-usage schedules trained on limited prior-usage data may lack accuracy, but they may increase in accuracy as more and more prior usages of the electric vehicle 4110 are recorded. A simple example of a predicted-usage schedule comprising four predicted usages is as follows. The predicted-usage schedule may contain additional or redundant information, such as arrival times, drive times, drive distances, average speeds, number of stops (e.g., stop signs, traffic lights, etc.), and so on. Further, the predicted-usage schedule may be supplemented with information indicating whether there are charging units in a vicinity of the location, as described later herein.
predicted usage #1:
   departure time: 6:00 AM
   departure location: home (location 1)
   arrival location: gym (location 2)
predicted usage #2:
   departure time: 8:20 AM
   departure location: gym (location 2)
   arrival location: office (location 3)
predicted usage #3:
   departure time: 11:30 PM
   departure location: office (location 3)
   arrival location: cafe (location 4)
predicted usage #4:
   departure time: 12:30 PM
   departure location: cafe (location 4)
   arrival location: home (location 5=location 1)

After the charging manager 4010 has determined the predicted-usage schedule for the electric vehicle 4110, the charging manager 4010 determines whether there are charging units in respective vicinities of the departure locations or the arrival locations indicated by the predicted-usage schedule. FIG. 4 shows several vicinities 4030, 4040, 4050, and 4060, which may be vicinities around, for example, a store, a gym, a factory, and a home, respectively. As shown in FIG. 4, there are two charging units 4070 and 4080 in vicinity 1; one charging unit 4090 in vicinity 2, no charging units in vicinity 3, and one charging unit in vicinity 4. For any location in a vicinity without a charging unit, the charging manager 4010 should ensure that the battery of the electric vehicle 4110 will have sufficient charge to arrive at the location and return from that location, (or arrive at the location and then arrive at a next or future location in a vicinity that has a charging unit). For any location in a vicinity that has a charging unit, the charging manager need only ensure that the electric vehicle 4110 will have sufficient charge to arrive at the location, because the electric vehicle may have the option to recharge at a charging unit in that vicinity.

However, determinations made by the charging manager 4010 as to when, where, and for how long the electric vehicle should be charged (i.e., the state-of-charge of the battery) may depend on many factors, such as the cost of electricity at charging stations in the vicinities of respective locations. Thus, the charging manager 4010 determines charging costs at the charging stations in the vicinities of the locations indicated by the predicted-usage schedule. Because such charging costs may depend on, for example, a time or day, a day of week, a season, and so on, the charging manager 4010 may obtain charging rates of the charging units from real-time or historical charging costs or the charging manager 4010 may determine such fluctuating charging costs based on obtained real-time or historical electricity rates in the vicinities of the charging units.

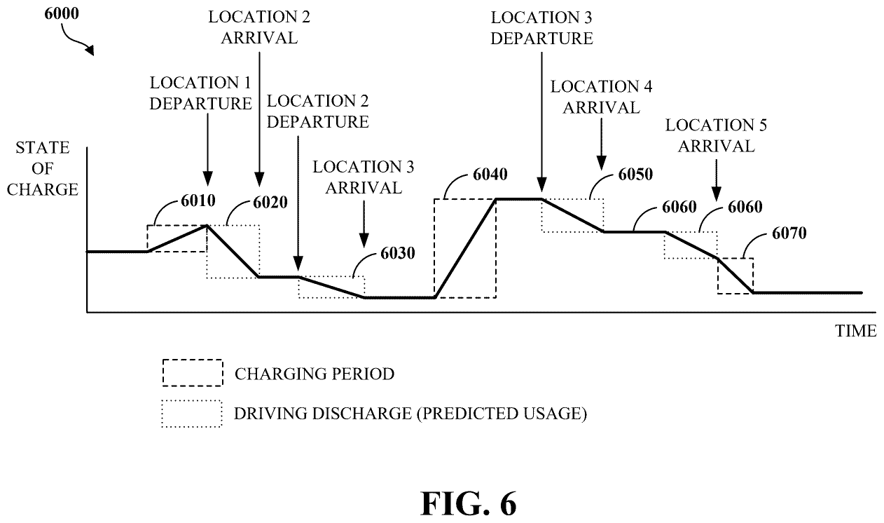

Based on the state-of-charge of the electric vehicle 4110, the predicted-usage schedule, and the charging costs, the charging manager 4010 generates a charging schedule for the electric vehicle 4110. FIG. 6 is an example of a charging schedule 6000. The charging schedule has charging periods 6010, 6040, and 6070 for adjusting the state-of-charge of the electric vehicle 4110 to accommodate upcoming predicted usages 6020, 6030, 6050, and 6060 of the predicted-usage schedule at a minimal total charging cost. An upcoming predicted usage is accommodated if the state-of-charge of the electric vehicle 4110 is sufficient to complete the predicted usage and to arrive at a charging unit for recharging, where such recharging may occur after a series of predicted usages are completed. In some implementations, the charging manager 4010 determines a charging schedule for the entire predicted-usage schedule, and therefore, the total charging costs is the cost to charge the electric vehicle 4110 to accommodate all predicted usages of the predicted-usage schedule. In some implementations, the charging manager 4010 determines a charging schedule for only a portion of the predicted-usage schedule, for example, for an upcoming 24-hour period, and therefore, the total charging costs is the cost to charge the electric vehicle 4110 to accommodate all predicted usages of that portion of the predicted-usage schedule. Note that a charging period may result in a reduction in the state-of-charge of the electric vehicle 4110, like charging period 6070 in FIG. 6. Such a charging period may correspond to a discharging of the battery of the electrical vehicle 4110 to charge a home-based backup-battery storage device.

The length of the charging schedule, i.e., how far into the future the charging schedule schedules, can be system-determined (e.g., by the charging manager 4010) or user-determined (e.g., by a driver or owner of the electric vehicle 4110). For example, a system-determined length may be a function of the amount of prior-usage data that has been used to determine the predicted-usage schedule, or the length may be a function of the accuracy of prior predicted usages (which can be determined by recording deviations between prior predicted usages and actual usages). A user-determined length may be established as a user-input.

The charging manager 4010 may calculate the minimal total charging cost based on a predetermined optimization algorithm. For example, various classes or types of algorithms can be used, such as linear programming, genetic algorithms, and simulating annealing. Additionally, variations and modifications of various algorithms can be used, such as Dijkstra's algorithm, Bellman-Ford algorithm, Floyd-Warshall algorithm, Prim's algorithm, Kruskal's algorithm, or branch-and-bound algorithm. Additionally, a system for minimizing total charging costs for a predicted-usage schedule may be modeled via Markov decision process that can be solved via simulation or analytical techniques.

As a simple example and with reference to FIG. 6 (which is not drawn to scale), assume the predicted-usage schedule shown earlier herein. Assume that only location 1, location 3, and location 5 (which is the same as location 1) have charging units in their respective vicinities, and the charging cost for the location-3 charging unit is less than that of the location-1 charging unit. One possible charging schedule would be to fully charge the electric vehicle at location 1, prior to starting predicted-usage 1, such that the state-of-charge is sufficient to complete all four predicted usages. However, a lower total charging cost would be to charge the electric vehicle 4110 with sufficient charge to complete predicted usages 1, 2, and 3, and to recharge the electric vehicle 4110 at location 3 where the charging costs are lower. Thus, in this simple example, the second charging schedule would be selected over the first charging schedule.

Although the simple example described above is illustrative, it does not account for other factors, such as length of time at each location, charging rate of a charging unit, distance from a location to a charging unit, real-time availability of a charging unit, traffic conditions, and so on, which may be included in the various implementations of the multifactor charge management disclosed herein. For example, in some implementations, the charging manager 4010 may prioritize various charging units in a vicinity of a location based on its proximity to the location; the charging manager 4010 may account for a duration from arrival time to departure time at a location; the charging manager 4010 may account for a charging rate of a charging unit; the charging manager 4010 may account for a service fee of a charging unit; the charging manager 4010 may synchronizing the charging schedule with a navigation system of the electric vehicle to optimize route planning and charging stops; the charging manager 4010 may adjust the charging schedule based on weather forecasts; the charging manager 4010 may incorporate scheduled usages of the electric vehicle into the charging schedule, where such scheduled usages may be obtained by the charging manager 4010 from external sources, such as a calendar application of a driver; the charging manager 4010 may incorporate user preferences, comprising at least one of preferred charging times or preferred charging locations, into the charging schedule; the charging manager 4010 may provide a notification to a user of the electric vehicle regarding the charging schedule, and may further prompt the user for input to approve or modify the charging schedule; and the charging manager 4010 may send the notification to the user device 4130, and the user device 4130 may further effectuate the prompt according to instructions received from the charging manager 4010.

In some implementations, the charging manager 4010 may optimize the charging schedule to reduce electrical grid load. For example, the charging manager 4010 may obtain, determine, or predict grid load at various times of day, and may determine the time and duration of certain charging periods to fall outside peak-load times. For example, in the exemplary charging schedule described above, the charging period at location 3 may occur during peak-load hours of the grid. If the charging manager 4010 is configured to reduce electrical grid load, for example based on user selection of such an option, then the charging manager 4010 may alter the charging schedule to reduce, or eliminate, the amount of charging that occurs at location 3 in favor of recharging the electric vehicle 4110 at location 5.

After the charging manager 4010 has generated the charging schedule, the charging manager 4010 may cause an individual one of the charging units to adjust the state-of-charge in accordance with the charging schedule. For example, when the electric vehicle 4110 is at a home location, the charging manager 4010 may instruct a home-based charging unit that is connected to the electric vehicle 4110 to adjust the state-of-charge of the electric vehicle 4110 according to the charging schedule. Such instructions may be communicated via the network 4020. In some implementations, the charging manager 4010 may communicate instructions, via the network 4020, to other charging units indicated by the predicted-usage schedule. In some implementations, such instructions may be communicated when or slightly before the electric vehicle 4110 arrives at the charging unit. In some implementations, such instructions may be communicated well in advance of when the electric vehicle 4110 arrives at the charging unit, for example, to effectuate a reservation of the charging unit.

With respect to implementation of a single-session optimizer, the charging manager 4010 may dynamically adjust the charging schedule based on one or more of: real-time variations in electricity prices; real-time traffic conditions; or real-time availability of charging units. The real-time electricity prices, real-time traffic conditions, or real-time availability of charging units may be obtained, for example, via a connection through the network 4020 to the electric vehicle 4110 or by way of a connection through the network 4020 to a charging unit, such as the charging unit 4100, that is or was recently connected to the electric vehicle 4110.

With respect to implementation of a long-term battery optimizer, the charging manager 4010 may incorporate predicted battery degradation rates to prolong battery lifespan into the charging schedule. In particular, the charging manager 4010 may obtain prior-charging data about the battery comprising at least one of fast-charging sessions, slow-charging sessions, and battery discharge depths. The prior-charging data may be obtained, for example, via a connection through the network 4020 to the electric vehicle 4110 or by way of a connection through the network 4020 to a charging unit, such as the charging unit 4100, that is or was recently connected to the electric vehicle 4110, or from one or more memories of the electric vehicle, such as the memory 1340 of FIG. 1. The charging manager 4010 may determine a state-of-health of the battery based on the prior-charging data; determine a maximum charging rate for the battery, based on the state-of-health, to satisfy a state-of-health target; and adjust the charging schedule based on the maximum charging rate. The state-of-health target may be a minimum desired performance of the battery at a future date, for example, according to an expected lifespan of the battery.

In some implementations, the charging manager 4010 may obtain a temperature of an environment of the electric vehicle. The temperature may be obtained for example, via a connection through the network 4020 to the electric vehicle 4110 or by way of a connection through the network 4020 to a charging unit, such as the charging unit 4100, that is or was recently connected to the electric vehicle 4110, or from one or more sensors of the electric vehicle, such as the sensor 1360 of FIG. 1. The charging manager 4010 may determine a state-of-health of the battery based on the temperature; determine a maximum charging rate for the battery, based on the state-of-health, to satisfy a state-of-health target; and adjust the charging schedule based on the maximum charging rate.

In some implementations, the charging manager 4010 may obtain additional prior-usage data comprising accelerations of the electric vehicle. The additional prior-usage data may be obtained for example, via a connection through the network 4020 to the electric vehicle 4110 or by way of a connection through the network 4020 to a charging unit, such as the charging unit 4100, that is or was recently connected to the electric vehicle 4110, or from one or more memories of the electric vehicle, such as the memory 1340 of FIG. 1. The charging manager 4010 may determine a state-of-health of the battery based on the additional prior-usage data; determine a maximum charging rate for the battery, based on the state-of-health, to satisfy a state-of-health target; and adjust the charging schedule based on the maximum charging rate.

For simplicity of explanation, each technique, or process, is depicted and described herein as a series of steps or operations. However, the steps or operations of the techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The techniques 7000, 8000, and 9000 described below are techniques for multifactor charge management for electric vehicles. These techniques may be implemented by a charging manager, such as the charging manager 4010 of FIG. 4. The charging manager 4010 may be one or more hardware instances of the computing device 3000, or it may be one or more software instances executing on one or more computing devices 3000, or it may be a combination thereof. Aspects of the charging manager 4010 may be implemented in a user device, such as user device 4130, in an electric vehicle, such as vehicle 2100, in a charging unit, such as an instance of the external object 2110 of FIG. 2, in a data processing center, such as the data-processing center 2400 of FIG. 2, or combinations thereof.

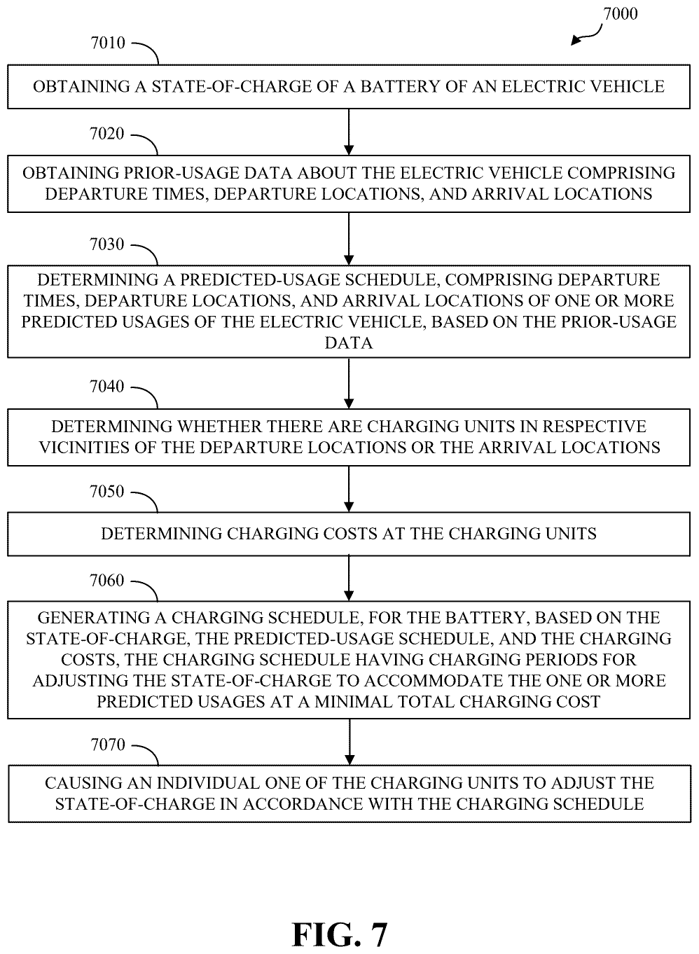

FIG. 7 is a flowchart of an example of a technique 7000 for multifactor charge management for electric vehicles that concerns multi-session optimization. The step 7010 comprises obtaining a state-of-charge of a battery of an electric vehicle. The electric vehicle may be the vehicle 2100 of FIG. 2. Obtaining the state-of-charge may be accomplished via a network, such as the network 4020 of FIG. 4, and one or more sensors, such as the sensor 1360 of FIG. 1 and/or a sensor component of peripheral 3010 of FIG. 3.

The step 7020 comprises obtaining prior-usage data about the electric vehicle comprising departure times, departure locations, and arrival locations. The prior-usage data may be obtained from the electrical vehicle via a network, such as the 4020 of FIG. 4. In some implementations, the prior-usage data may be stored in a cloud server or online database, and the prior-usage data may be obtained via the network therefrom.

The step 7030 comprises determining a predicted-usage schedule, comprising departure times, departure locations, and arrival locations of one or more predicted usages of the electric vehicle, based on the prior-usage data. In some implementations, the predicted-usage schedule is determined using one or more machine-learning algorithms (which may also be referred to herein as artificial-intelligence algorithms). In some implementations, the charging manager may prioritize various charging units in a vicinity of a location based on its proximity to the location.

The step 7040 comprises determining whether there are charging units in respective vicinities of the departure locations or the arrival locations. In some implementations, a user may provide input to the charging manager to specify areas and shapes of various vicinities, for example, by drawing a shape around a location indicated on a map or satellite image via a graphical user display. In some implementations, a user may assign preferences to different charging units, e.g., to cause the charging manager weigh preferences for charging units when determining a charging schedule.

The step 7050 comprises determining charging costs at the charging units. In some implementations, the charging manager may obtain charging rates of the charging units from real-time or historical charging costs or the charging manager may determine such fluctuating charging costs based on obtained real-time or historical electricity rates in the vicinities of the charging units.

The step 7060 comprises generating a charging schedule, for the battery, based on the state-of-charge, the predicted-usage schedule, and the charging costs, the charging schedule having charging periods for adjusting the state-of-charge to accommodate the one or more predicted usages at a minimal total charging cost. The charging manager 4010 may calculate the minimal total charging cost based on a predetermined optimization algorithm. In some implementations, the charging manager may dynamically adjust the charging schedule based on real-time or predicted traffic conditions. In some implementations, the charging manager may dynamically adjust the charging schedule based on real-time or predicted availability of charging units. In some implementations, the charging manager may adjust, statically or dynamically, the charging schedule to account for variations in electricity prices at different times of day. In some implementations, the charging manager may account for a duration from arrival time to departure time at a location. In some implementations, the charging manager may account for a charging rate of a charging unit. In some implementations, the charging manager may synchronizing the charging schedule with a navigation system of the electric vehicle to optimize route planning and charging stops. In some implementations, the charging manager may statically or dynamically adjust the charging schedule based on weather forecasts. In some implementations, the charging manager may incorporate scheduled usages of the electric vehicle into the charging schedule. Such scheduled usages may be obtained by the charging manager from external sources, such as a calendar application of a driver. In some implementations, the charging manager may incorporate user preferences, comprising at least one of preferred charging times or preferred charging locations, into the charging schedule. In some implementations, the charging manager may incorporate predicted battery degradation rates to prolong battery lifespan into the charging schedule. In some implementations, the charging manager may provide a notification to a user of the electric vehicle regarding the charging schedule, and may further prompt the user for input to approve or modify the charging schedule. The charging manager may send the notification to a user device, such as the user device 4130 of FIG. 4, and the user device may further effectuate the prompt according to instructions received from the charging manager. In some implementations, the charging manager 4010 may optimize the charging schedule to reduce electrical grid load.

The step 7070 comprises causing an individual one of the charging units to adjust the state-of-charge in accordance with the charging schedule.

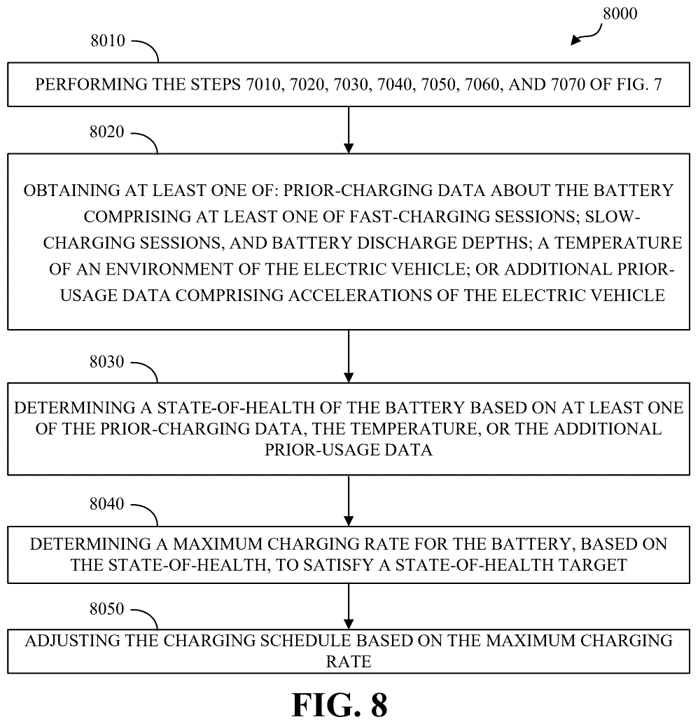

FIG. 8 is a flowchart of an example of a technique 8000 for multifactor charge management for electric vehicles that concerns long-tern battery optimization. The step 8010 comprises performing the steps 7010, 7020, 7030, 7040, 7050, 7060, and 7070 of FIG. 7.

The step 8020 comprises obtaining at least one of: prior-charging data about the battery comprising at least one of fast-charging sessions; slow-charging sessions, and battery discharge depths; a temperature of an environment of the electric vehicle; or additional prior-usage data comprising accelerations of the electric vehicle. The temperature may be obtained for example, via one or more sensors of the electric vehicle, such as the sensor 1360 of FIG. 1.

The step 8030 comprises determining a state-of-health of the battery based on at least one of the prior-charging data, the temperature, or the additional prior-usage data.

The step 8040 comprises determining a maximum charging rate for the battery, based on the state-of-health, to satisfy a state-of-health target.

The step 8050 comprises adjusting the charging schedule based on the maximum charging rate.

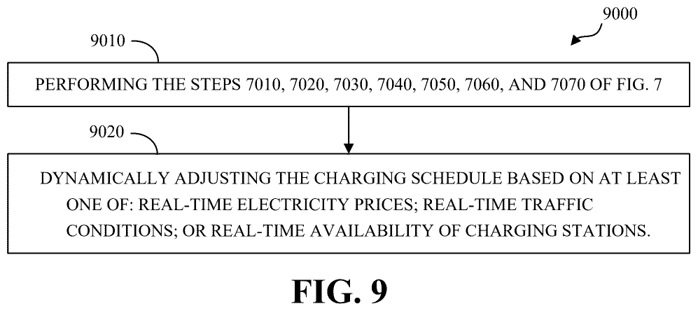

FIG. 9 is a flowchart of an example of a technique 9000 for multifactor charge management for electric vehicles that concerns single-session optimization. The step 9010 comprises performing the steps 7010, 7020, 7030, 7040, 7050, 7060, and 7070 of FIG. 7.

The step 9020 comprises dynamically adjusting the charging schedule based on at least one of: real-time electricity prices; real-time traffic conditions; or real-time availability of charging stations. The real-time electricity prices, real-time traffic conditions, or real-time availability of charging units may be obtained, for example, via a connection through the network 4020 to the electric vehicle 4110 or by way of a connection through the network 4020 to a charging unit, such as the charging unit 4100, that is or was recently connected to the electric vehicle 4110.

Several scenarios are provided below further illustrate the disclosed multifactor charge management for electric vehicles that includes multi-session optimization, long-term battery optimization, and single-session optimization.

Scenario #1: An individual arrives at her office in an electric vehicle that indicates a 60% state-of-charge. The individual plugs in the electric vehicle to a charging unit to charge the batteries of the electric vehicle.
Due to the hot weather today, the charging manager 4010, implementing the long-term battery optimizer, restricts the maximum charging rate to 10 kW to preserve battery health.
Typically, the individual goes straight home after work each day, which is a one-way drive that requires a 30% state-of-charge to complete. However, sometimes on Wednesdays the individual will stop by another location on the way home, which requires an extra 20% state-of-charge (50% total). To prevent the state-of-charge from falling below a minimal baseline state-of-charge (e.g., 10% state-of-charge), the charging manager 4010, implementing the multi-session optimizer, sets a target state-of-charge of 65% for the charging of the battery at the charging unit located at the individual's office.
Again, due to the hot weather today, the individual's office, which provides the charging unit, request in the morning that the individual's electric vehicle discharge from 2:00 pm to 4:00 pm to offset the electricity used by the air conditioner at the office (e.g., peak shaving). The charging manager 4010, implementing the single-session optimizer, generates a charging schedule that includes: (1) discharging the electric vehicle's battery from 60% to 40% state-of-charge from 2:00 pm to 4:00 pm to achieve the office peak shaving with power constraint of 10 KW, which is determined by long term battery optimizer; and (2) charging the electric vehicle's battery from 40% to 65% state-of-charge from 4:00 pm to 6:30 pm to achieve the target state-of-charge determined by the multi-session optimizer.

Scenario #2: Partway through a workday, the weather forecast is updated to reflect hotter-than-expected temperatures. To reduce demand on the power grid, the power utility company has signaled that they will likely increase the cost of electricity from 4:00PM-9:00 PM (e.g., like a demand-reduction event).
An owner of an electric vehicle owns and operates a bi-directional charger at home (i.e., a charger that can either charge or discharge batteries of an electric vehicle). The charging manager 4010, implementing the multi-session optimizer, estimates that the owner will save $10 on her electricity bill if she discharges 50% of the state-of-charge of the battery of her electric vehicle as soon as she gets home from the office. The charging manager 4010, implementing the multi-session optimizer, therefore increases the target state-of-charge, at the charging unit at the office where her electric vehicle is currently plugged in, to 90%, which leaves sufficient state-of-charge for the individual to complete the one-way drive home (requiring 30% state-of-charge), to discharge an additional 50% state-of-charge, and to leave a 10% minimal baseline state-of-charge.

Scenario #3: During the middle of the week, an electric vehicle owner expects a high likelihood of higher electricity prices on Friday due to the forecasted hot weather.
The owner opens an app on her phone that provides an interface to the charging manager 4010, and inputs information indicating the increase in electricity prices for Friday. The charging manager 4010, implementing the multi-session optimizer, determines that the electric vehicle's battery should have a 90% state-of-charge on Friday night to be ready for a scheduled weekend road trip. Instead of generating a charging schedule to fully charge the battery from nearly depleted to the required 90% state-of-charge in one charging session on Friday, the charging manager 4010 determines it will cost less to gradually charge the battery to 90% state-of-charge over the next few days. The charging manager 4010 generates a charging schedule that charges the battery to 60% state-of-charge by Wednesday evening, to 80% state-of-charge by Thursday evening, and to 90% state-of-charge by Friday evening.

Scenario #4: The daughter of an electric vehicle owner recently received her driver's license and has been driving the electric vehicle to school a couple days per week. The daughter is a more aggressive driver than the mother, which is causing more strain on the battery.
After a month of the daughter's driving, the charging manager 4010, implementing the long-term battery optimizer, forecasts that the battery's state-of-health is now declining at a faster rate than before. The charging manager 4010 determines that, to satisfy a predefined state-of-health target of the battery at the end of the year, the charging manager must reduce the maximum charging rate for the battery to 8 kW from 12 KW, where the reduced charging rate compensates for the increased battery degradation caused by the aggressive driving. The next time the electric vehicle is plugged in to a charging unit, the charging manager 4010, implementing the multi-session optimizer, constrains the charging rate to the maximum 8 kW.

The above-described techniques can be implemented as a method, a system, and a non-transitory computer-readable medium.

In an example implementation as a method, to be executed by a computing device, the method comprises: obtaining a state-of-charge of a battery of an electric vehicle; obtaining prior-usage data about the electric vehicle comprising departure times, departure locations, and arrival locations; determining a predicted-usage schedule, comprising departure times, departure locations, and arrival locations of one or more predicted usages of the electric vehicle, based on the prior-usage data; determining whether there are charging units in respective vicinities of the departure locations or the arrival locations; determining charging costs at the charging units; generating a charging schedule, for the battery, based on the state-of-charge, the predicted-usage schedule, and the charging costs, the charging schedule having charging periods for adjusting the state-of-charge to accommodate the one or more predicted usages at a minimal total charging cost; and causing an individual one of the charging units to adjust the state-of-charge in accordance with the charging schedule.

In some implementations, the method further comprises: adjusting the charging schedule based on weather forecasts.

In some implementations, the method further comprises: utilizing data from onboard sensors of electric vehicle to obtain the state-of-charge.

In some implementations, the method further comprises: prioritizing charging units based on their proximity to departure or arrival locations.

In some implementations, the method further comprises: calculating the minimal total charging cost based on a predetermined optimization algorithm.

In some implementations, the method further comprises: providing a notification to a user of the electric vehicle regarding the charging schedule.

In some implementations, the method further comprises: synchronizing the charging schedule with a navigation system of the electric vehicle to optimize route planning and charging stops.

In some implementations, the method further comprises: incorporating scheduled usages of the electric vehicle into the charging schedule.

In some implementations, the method further comprises: incorporating user preferences, comprising at least one of preferred charging times or preferred charging locations, into the charging schedule.

In some implementations, the method further comprises: optimizing the charging schedule to reduce electrical grid load.

In some implementations, the method further comprises: integrating data from external sources, such as calendar events, to enhance an accuracy of the predicted-usage schedule.

In some implementations, the method further comprises: obtaining prior-charging data about the battery comprising at least one of fast-charging sessions, slow-charging sessions, and battery discharge depths; determining a state-of-health of the battery based on the prior-charging data; determining a maximum charging rate for the battery, based on the state-of-health, to satisfy a state-of-health target; and adjusting the charging schedule based on the maximum charging rate.

In some implementations, the method further comprises: obtaining a temperature of an environment of the electric vehicle; determining a state-of-health of the battery based on the temperature; determining a maximum charging rate for the battery, based on the state-of-health, to satisfy a state-of-health target; and adjusting the charging schedule based on the maximum charging rate.

In some implementations, the method further comprises: obtaining additional prior-usage data comprising accelerations of the electric vehicle; determining a state-of-health of the battery based on the additional prior usage data; determining a maximum charging rate for the battery, based on the state-of-health, to satisfy a state-of-health target; and adjusting the charging schedule based on the maximum charging rate.

In some implementations, the method further comprises: dynamically adjusting the charging schedule based on real-time electricity prices.

In some implementations, the method further comprises: dynamically adjusting the charging schedule based on real-time traffic conditions.

In some implementations, the method further comprises: dynamically adjusting the charging schedule based on real-time availability of charging units.

In another example implementation as a system, the system comprises one or more memories; and one or more processors configured to execute instructions stored in the one or more memories to: obtain a state-of-charge of a battery of an electric vehicle; obtain prior-usage data about the electric vehicle comprising departure times, departure locations, and arrival locations; determine a predicted-usage schedule, comprising departure times, departure locations, and arrival locations of one or more predicted usages of the electric vehicle, based on the prior-usage data; determine whether there are charging units in respective vicinities of the departure locations or the arrival locations; determine charging costs at the charging units; generate a charging schedule, for the battery, based on the state-of-charge, the predicted-usage schedule, and the charging costs, the charging schedule having charging periods for adjusting the state-of-charge to accommodate the one or more predicted usages at a minimal total charging cost; and cause an individual one of the charging units to adjust the state-of-charge in accordance with the charging schedule.

In some implementations, the instructions include instructions to: obtain at least one of: prior-charging data about the battery comprising at least one of fast-charging sessions; slow-charging sessions, and battery discharge depths; a temperature of an environment of the electric vehicle; or additional prior-usage data comprising accelerations of the electric vehicle; determine a state-of-health of the battery based on at least one of the prior-charging data, the temperature, or the additional prior-usage data; determine a maximum charging rate for the battery, based on the state-of-health, to satisfy a state-of-health target; and adjust the charging schedule based on the maximum charging rate.

In another example implementation as a non-transitory computer-readable medium, the non-transitory computer-readable medium stores instructions operable to cause one or more processors to perform operations comprising: obtaining a state-of-charge of a battery of an electric vehicle; obtaining prior-usage data about the electric vehicle comprising departure times, departure locations, and arrival locations; determining a predicted-usage schedule, comprising departure times, departure locations, and arrival locations of one or more predicted usages of the electric vehicle, based on the prior-usage data; determining whether there are charging units in respective vicinities of the departure locations or the arrival locations; determining charging costs at the charging units; generating a charging schedule, for the battery, based on the state-of-charge, the predicted-usage schedule, and the charging costs, the charging schedule having charging periods for adjusting the state-of-charge to accommodate the one or more predicted usages at a minimal total charging cost; and causing an individual one of the charging units to adjust the state-of-charge in accordance with the charging schedule.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described to allow easy understanding of the disclosure are not limiting. On the contrary, the disclosure covers various modifications and equivalent arrangements included within the scope of the appended claims, which scope is to be accorded the broadest interpretation to encompass all such modifications and equivalent structure as is permitted under the law.

What is claimed is:

1. A method, to be executed by a computing device, comprising:
obtaining a state-of-charge of a battery of an electric vehicle;
obtaining prior-usage data about the electric vehicle comprising departure times, departure locations, and arrival locations;
determining a predicted-usage schedule, comprising departure times, departure locations, and arrival locations of one or more predicted usages of the electric vehicle, based on the prior-usage data;
determining whether there are charging units in respective vicinities of the departure locations or the arrival locations;
determining charging costs at the charging units;
generating a charging schedule, for the battery, based on the state-of-charge, the predicted-usage schedule, and the charging costs, the charging schedule having charging periods for adjusting the state-of-charge to accommodate the one or more predicted usages at a minimal total charging cost; and
causing an individual one of the charging units to adjust the state-of-charge in accordance with the charging schedule.

2. The method of claim 1, further comprising:
adjusting the charging schedule based on weather forecasts.

3. The method of claim 1, further comprising:
utilizing data from onboard sensors of electric vehicle to obtain the state-of-charge.

4. The method of claim 1, further comprising:
prioritizing charging units based on their proximity to departure or arrival locations.

5. The method of claim 1, further comprising:
calculating the minimal total charging cost based on a predetermined optimization algorithm.

6. The method of claim 1, further comprising:
providing a notification to a user of the electric vehicle regarding the charging schedule.

7. The method of claim 1, further comprising:
synchronizing the charging schedule with a navigation system of the electric vehicle to optimize route planning and charging stops.

8. The method of claim 1, further comprising:
incorporating scheduled usages of the electric vehicle into the charging schedule.

9. The method of claim 1, further comprising:
incorporating user preferences, comprising at least one of preferred charging times or preferred charging locations, into the charging schedule.

10. The method of claim 1, further comprising:
optimizing the charging schedule to reduce electrical grid load.

11. The method of claim 1, further comprising:
integrating data from external sources, such as calendar events, to enhance an accuracy of the predicted-usage schedule.

12. The method of claim 1, further comprising:
obtaining prior-charging data about the battery comprising at least one of fast-charging sessions, slow-charging sessions, and battery discharge depths;
determining a state-of-health of the battery based on the prior-charging data;
determining a maximum charging rate for the battery, based on the state-of-health, to satisfy a state-of-health target; and
adjusting the charging schedule based on the maximum charging rate.

13. The method of claim 1, further comprising:
obtaining a temperature of an environment of the electric vehicle;
determining a state-of-health of the battery based on the temperature;
determining a maximum charging rate for the battery, based on the state-of-health, to satisfy a state-of-health target; and
adjusting the charging schedule based on the maximum charging rate.

14. The method of claim 1, further comprising:
obtaining additional prior-usage data comprising accelerations of the electric vehicle;
determining a state-of-health of the battery based on the additional prior-usage data;
determining a maximum charging rate for the battery, based on the state-of-health, to satisfy a state-of-health target; and
adjusting the charging schedule based on the maximum charging rate.

15. The method of claim 1, further comprising:
dynamically adjusting the charging schedule based on real-time electricity prices.

16. The method of claim 1, further comprising:
dynamically adjusting the charging schedule based on real-time traffic conditions.

17. The method of claim 1, further comprising:
dynamically adjusting the charging schedule based on real-time availability of charging units.

18. A system, comprising:
one or more memories; and
one or more processors configured to execute instructions stored in the one or more memories to:
obtain a state-of-charge of a battery of an electric vehicle;
obtain prior-usage data about the electric vehicle comprising departure times, departure locations, and arrival locations;
determine a predicted-usage schedule, comprising departure times, departure locations, and arrival locations of one or more predicted usages of the electric vehicle, based on the prior-usage data;
determine whether there are charging units in respective vicinities of the departure locations or the arrival locations;
determine charging costs at the charging units;
generate a charging schedule, for the battery, based on the state-of-charge, the predicted-usage schedule, and the charging costs, the charging schedule having charging periods for adjusting the state-of-charge to accommodate the one or more predicted usages at a minimal total charging cost; and
cause an individual one of the charging units to adjust the state-of-charge in accordance with the charging schedule.

19. The system of claim 18, wherein the instructions include instructions to:
obtain at least one of:
prior-charging data about the battery comprising at least one of fast-charging sessions;
slow-charging sessions, and battery discharge depths;
a temperature of an environment of the electric vehicle; or
additional prior-usage data comprising accelerations of the electric vehicle;
determine a state-of-health of the battery based on at least one of the prior-charging data, the temperature, or the additional prior-usage data;
determine a maximum charging rate for the battery, based on the state-of-health, to satisfy a state-of-health target; and
adjust the charging schedule based on the maximum charging rate.

20. A non-transitory computer-readable medium storing instructions operable to cause one or more processors to perform operations comprising:
obtaining a state-of-charge of a battery of an electric vehicle;
obtaining prior-usage data about the electric vehicle comprising departure times, departure locations, and arrival locations;
determining a predicted-usage schedule, comprising departure times, departure locations, and arrival locations of one or more predicted usages of the electric vehicle, based on the prior-usage data;
determining whether there are charging units in respective vicinities of the departure locations or the arrival locations;
determining charging costs at the charging units;
generating a charging schedule, for the battery, based on the state-of-charge, the predicted-usage schedule, and the charging costs, the charging schedule having charging periods for adjusting the state-of-charge to accommodate the one or more predicted usages at a minimal total charging cost; and
causing an individual one of the charging units to adjust the state-of-charge in accordance with the charging schedule.
